(19) United States
(12) Patent Application Publication
(10) Pub. No.: US 2026/0089271 A1
(43) Pub. Date: Mar. 26, 2026

(54) PRINTING DEVICE AND AMOUNT-OF-CONVEYANCE ADJUSTMENT METHOD THEREFOR

(71) Applicant: SEIKO EPSON CORPORATION, Tokyo (JP)

(72) Inventor: Motoki MASUDA, SHIOJIRI-SHI (JP)

(21) Appl. No.: 19/338,354

(22) Filed: Sep. 24, 2025

(30) Foreign Application Priority Data
Sep. 26, 2024 (JP) 2024-166994

(51) Int. Cl. H04N 1/00

(52) U.S. Cl. CPC H04N 1/00045; H04N 1/00015; H04N 1/00031; H04N 1/00063; H04N 1/00087; H04N 2201/0006

(57) ABSTRACT

A printing device includes a recording head, a main scanning unit, a conveyance unit, and a control unit. The conveyance unit includes an upstream drive roller including a first gear, a downstream drive roller including a second gear, and a rotary element meshing with the first gear and the second gear. The control unit performs control for ejecting droplets to a cantilevered print area from the recording head moving along a main scanning direction in a state where a phase of the rotary element is a first phase and thus forming a first test pattern, and ejecting droplets to the cantilevered print area from the recording head moving along the main scanning direction in a state where the phase of the rotary element is one or more second phases shifted from the first phase by k(n/m) cycles and thus forming a second test pattern.

The present application is based on, and claims priority from JP Application Serial Number 2024-166994, filed Sep. 26, 2024, the disclosure of which is hereby incorporated by reference herein in its entirety.

### BACKGROUND

### 1. Technical Field

The present disclosure relates to a printing device that conveys a medium between main scans, and an amount-of-conveyance adjustment method therefor.

### 2. Related Art

As a printing device, an inkjet printer that alternately repeats a main scan in which liquid droplets are ejected onto a medium from a recording head moving along a main scanning direction and a sub scan in which the medium is conveyed in a conveyance direction intersecting the main scanning direction between main scans, is known. A conveyance unit that conveys the medium includes an upstream conveyance roller pair located upstream of a recording head in the conveyance direction and a downstream conveyance roller pair located downstream of the recording head. The upstream conveyance roller pair includes an upstream drive roller, and the downstream conveyance roller pair includes a downstream drive roller. When the drive roller rotates in a state where at least one of the upstream conveyance roller pair and the downstream conveyance roller pair nips the medium, the medium is returned in the conveyance direction.

The amount of conveyance of the medium in each sub scan may include an error due to the eccentricity of the drive roller, the cross-sectional shape of the drive roller that is not a perfect circle, or the like. This error causes density unevenness, for example, light streaks such as white streaks and dark streaks such as black streaks. The recording device disclosed in JP-A-2024-51459 can record, on a medium, a test pattern group that is useful for correctly acquiring an adjustment value for eliminating the influence of a conveyance roller error, which is the above-described error, as much as possible, and thus suppressing density unevenness.

JP-A-2024-51459 is an example of the related art.

However, it is found that even when the adjustment value for suppressing the conveyance roller error is set in the printing device, density unevenness occurs in an area at an end part in the conveyance direction, of a print area on the medium.

### SUMMARY

According to an aspect of the present disclosure, a printing device configured to be able to print a test pattern group for acquiring an adjustment value of an amount of conveyance of a medium is provided, the printing device including: a recording head configured to be able to eject droplets onto the medium; a main scanning unit configured to move the recording head along a main scanning direction; a conveyance unit configured to convey the medium in a conveyance direction intersecting the main scanning direction; and a control unit configured to control operations of the recording head, the main scanning unit, and the conveyance unit, wherein the conveyance unit includes: an upstream drive roller including a first gear and located upstream of the recording head in the conveyance direction; a downstream drive roller including a second gear and located downstream of the recording head in the conveyance direction; and a rotary element meshing with the first gear and the second gear, at least one of the upstream drive roller and the downstream drive roller rotates in contact with the medium and thus conveys the medium in the conveyance direction, a print area on the medium includes a cantilevered print area where the medium is conveyed in a state where one of the upstream drive roller and the downstream drive roller is separated from the medium, the test pattern group includes a first test pattern and one or more second test patterns, and the control unit performs first control for forming the first test pattern in the cantilevered print area in a state where the rotary element is in a phase based on a first phase as a reference and second control for forming the second test pattern in the cantilevered print area in a state where the rotary element is in a phase based on one or more second phases shifted from the first phase by k(n/m) cycles as a reference, where m is an integer of 2 or more, n is an integer of 1 or more and less than m, and k is all integers from 1 to m−1.

According to another aspect of the present disclosure, an amount-of-conveyance adjustment method for a printing device is provided, the printing device including a recording head configured to be able to eject droplets onto the medium, a main scanning unit configured to move the recording head along a main scanning direction, and a conveyance unit configured to convey the medium in a conveyance direction intersecting the main scanning direction, the printing device being configured to be able to print a test pattern group for acquiring an adjustment value of an amount of conveyance of the medium, wherein the conveyance unit includes: an upstream drive roller including a first gear and located upstream of the recording head in the conveyance direction; a downstream drive roller including a second gear and located downstream of the recording head in the conveyance direction; and a rotary element meshing with the first gear and the second gear, at least one of the upstream drive roller and the downstream drive roller rotates in contact with the medium and thus conveys the medium in the conveyance direction, a print area on the medium includes a cantilevered print area where the medium is conveyed in a state where one of the upstream drive roller and the downstream drive roller is separated from the medium, the test pattern group includes a first test pattern and one or more second test patterns, and the amount-of-conveyance adjustment method includes: a first process of forming the first test pattern in the cantilevered print area in a state where the rotary element is in a phase based on a first phase as a reference; a second process of forming the second test pattern in the cantilevered print area in a state where the rotary element is in a phase based on one or more second phases shifted from the first phase by k(n/m) cycles as a reference, where m is an integer of 2 or more, n is an integer of 1 or more and less than m, and k is all integers from 1 to m−1; and a third process of adjusting the amount of conveyance, based on the first test pattern and the one or more second test patterns.

### BRIEF DESCRIPTION OF THE DRAWINGS

FIG. 1 schematically shows an example of a printing device.

FIG. 2 schematically shows an example of a recording head and a print image.

FIG. 3 schematically shows an example of upper-end printing, double-supported printing, and lower-end printing.

FIG. 4 schematically shows an example of the structure of a conveyance unit.

FIG. 5 schematically shows an example of calculating an adjustment value from a first test pattern and a second test pattern.

FIG. 6 is a flowchart schematically showing an example of amount-of-conveyance adjustment processing.

FIG. 7 schematically shows an example of printing a test pattern group.

FIGS. 8A and 8B are schematically show an example of adjusting the amount of conveyance of the medium.

FIG. 9 schematically shows another example of the test pattern group.

### DESCRIPTION OF EMBODIMENTS

An embodiment of the present disclosure will be described below. Of course, the embodiment below merely represents an example of the present disclosure, and not all the features described in the embodiment are necessarily essential to the solution disclosed herein.

### (1) Overview of Aspects Included in Present Disclosure

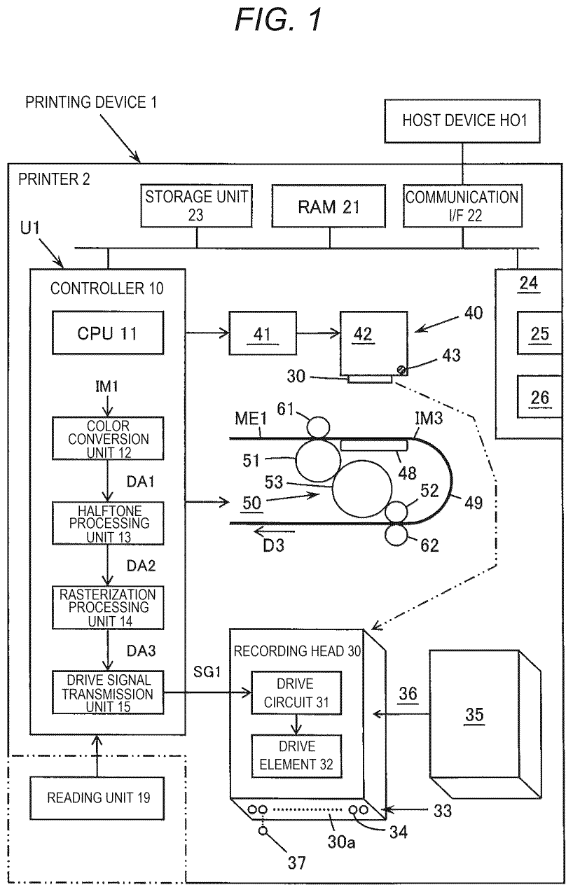

First, an overview of aspects included in the present disclosure will be described with reference to examples shown in FIGS. 1 to 9. Note that the drawings in the present application schematically show examples, and that the magnification in each direction shown in the drawings may vary and the drawings may not be consistent with each other. Of course, each element in the aspects of the present disclosure is not limited to the specific example indicated by the reference sign. In “Overview of Aspects Included in Present Disclosure”, a term or phrase in parentheses represents a supplementary explanation of the immediately preceding term or phrase.

In the present application, a numerical range “Min to Max” refers to a range from a minimum value Min or more to a maximum value Max or less.

### Aspect 1

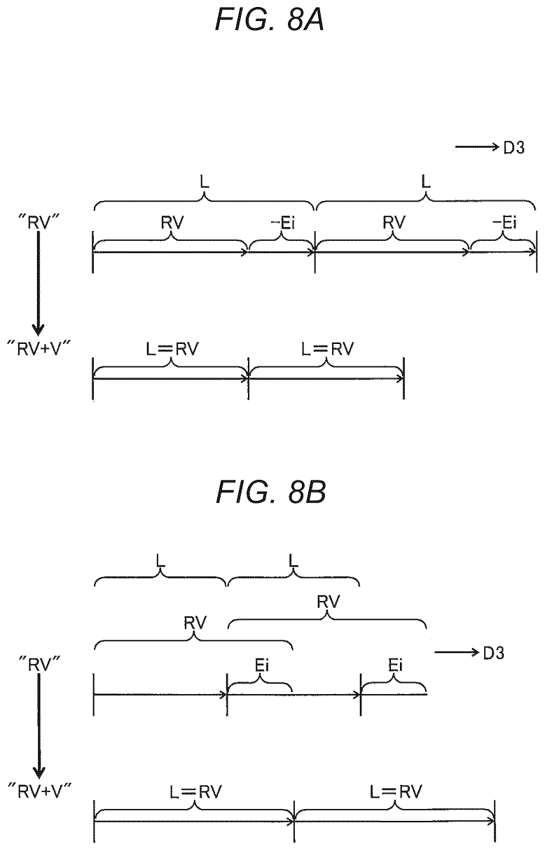

As illustrated in FIGS. 1 to 4, a printing device 1 according to an aspect is a printing device 1 that can print a test pattern group TP0 for acquiring an adjustment value V of the amount of conveyance (for example, an amount of conveyance L shown in FIG. 8A) of a medium ME1, and includes a recording head 30, a main scanning unit 40, a conveyance unit 50, and a control unit U1. The recording head 30 can eject droplets 37 onto the medium ME1. The main scanning unit 40 moves the recording head 30 along a main scanning direction D1. The conveyance unit 50 conveys the medium ME1 in a conveyance direction D3 intersecting the main scanning direction D1. The control unit U1 controls operations of the recording head 30, the main scanning unit 40, and the conveyance unit 50.

The conveyance unit 50 includes an upstream drive roller 51, a downstream drive roller 52, and a rotary element (for example, a spur gear 53). The upstream drive roller 51 includes a first gear 51a and is located upstream of the recording head 30 in the conveyance direction D3. The downstream drive roller 52 includes a second gear 52a and is located downstream of the recording head 30 in the conveyance direction D3. The rotary element (53) meshes with the first gear 51a and the second gear 52a. In the conveyance unit 50, at least one of the upstream drive roller 51 and the downstream drive roller 52 rotates in contact with the medium ME1 and thus conveys the medium ME1 in the conveyance direction D3.

A print area AR0 on the medium ME1 includes a cantilevered print area AR2 where the medium ME1 is conveyed in a state where one of the upstream drive roller 51 and the downstream drive roller 52 is separated from the medium. The test pattern group TP0 includes a first test pattern TP1 and one or more second test patterns TP2.

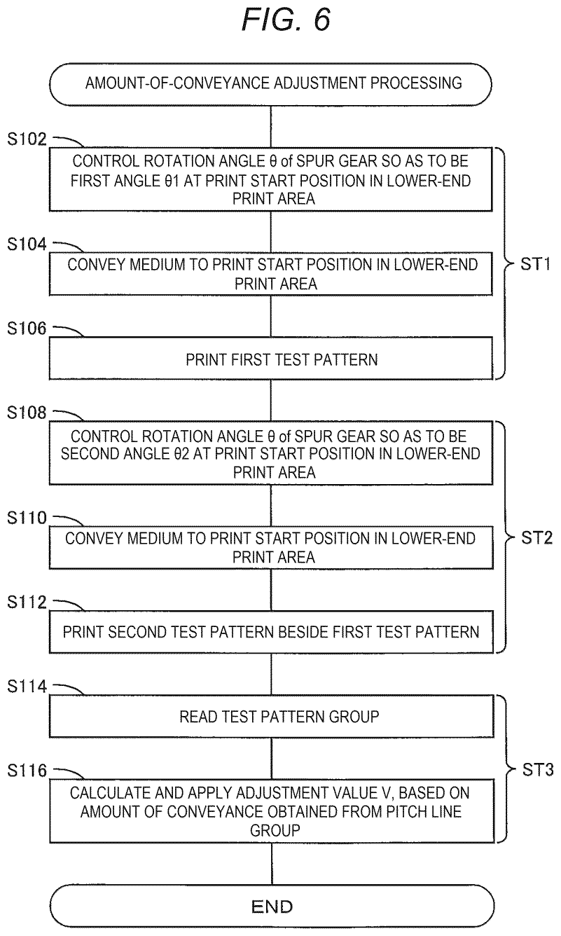

The control unit U1 performs the following processing as illustrated in FIG. 6.

(a1) First control (for example, steps S102 to S106) for forming the first test pattern TP1 in the cantilevered print area AR2 in a state where the rotary element (53) is in a phase (for example, a rotation angle) based on a first phase (for example, a first angle θ1) as a reference (for example, an initial angle).

(a2) Second control (for example, steps S108 to S112) for forming the second test pattern TP2 in the cantilevered print area AR2 in a state where the rotary element (53) is in a phase with one or more second phases (for example, a second angle θ2) shifted from the first phase (θ1) by k(n/m) cycles as a reference (for example, an initial angle), where m is an integer of 2 or more, n is an integer of 1 or more and less than m, and k is all integers from 1 to m−1.

As a result of a test, it is found that in the cantilevered print area AR2, where the medium ME1 is conveyed in the state where one of the upstream drive roller 51 and the downstream drive roller 52 is separated from the medium, density unevenness considered to depend on the phase of the rotary element (53) instead of the drive roller occurs. In a double-supported print area AR1 where the medium ME1 is conveyed in a state where both the upstream drive roller 51 and the downstream drive roller 52 are in contact with the medium, the above-described density unevenness is not confirmed.

In the above aspect, the first test pattern TP1 is printed in the cantilevered print area AR2 in the state where the rotary element (53) is in a phase based on the first phase (θ1) as a reference, and the second test pattern TP2 is printed in the cantilevered print area AR2 in the state where the rotary element (53) is in a phase based on the one or more second phases (θ2) shifted from the first phase (θ1) by k(n/m) cycles as a reference. Therefore, based on the printing position of the first test pattern TP1 and the printing position of the one or more second test patterns TP2, the adjustment value V can be determined so as to cancel the conveyance error depending on the phase of the rotary element (53), and the amount of conveyance of the medium ME1 can be adjusted so as to reduce the foregoing conveyance error. Therefore, according to the aspect, a printing device that can print a test pattern group that is useful for acquiring an adjustment value for reducing a conveyance error occurring in an area at an end part in the conveyance direction, of a print area on the medium, can be provided.

Various examples of the above-described aspect are conceivable.

The medium means an object conveyed by the conveyance unit, and is not limited to only a medium on which printing is performed, and may be a stacked body formed of two or more sheets stacked on each other, such as a stacked body of a first medium on which printing is performed and a second medium that supports the first medium.

Examples of the rotary element include a gear, a toothed belt, a chain, and the like. The rotary element may be a combination of a plurality of elements selected from the above-described elements, such as a combination of a plurality of gears. Examples of the gear include a spur gear, a bevel gear, a helical gear, and the like.

The phase of the rotary element can also be referred to as the rotational position in the rotary element. When the rotary element makes a circular motion like a spur gear or the like, the rotation angle of the rotary element is equivalent to the phase of the rotary element. When the rotary element is a combination of a plurality of elements, the phase of the rotary element is a phase in which the least common multiple of the circumferential lengths of the elements is the circumferential length of the rotary element.

The conveyance unit may transfer the driving force from the rotary element to both of the drive rollers, may transfer the driving force from the upstream drive roller to the downstream drive roller via the rotary element, or may transfer the driving force from the downstream drive roller to the upstream drive roller via the rotary element.

The cantilevered print area may be an upper-end print area on the upper end side in the conveyance direction, of the print area on the medium, or may be a lower-end print area on the lower end side in the conveyance direction, of the print area for the medium.

In the present application, “first”, “second”, and so on are terms used to identify each of a plurality of elements having similarities, and do not mean the order of the elements.

Of course, the above-described additional remarks also apply to the aspects described below.

### Aspect 2

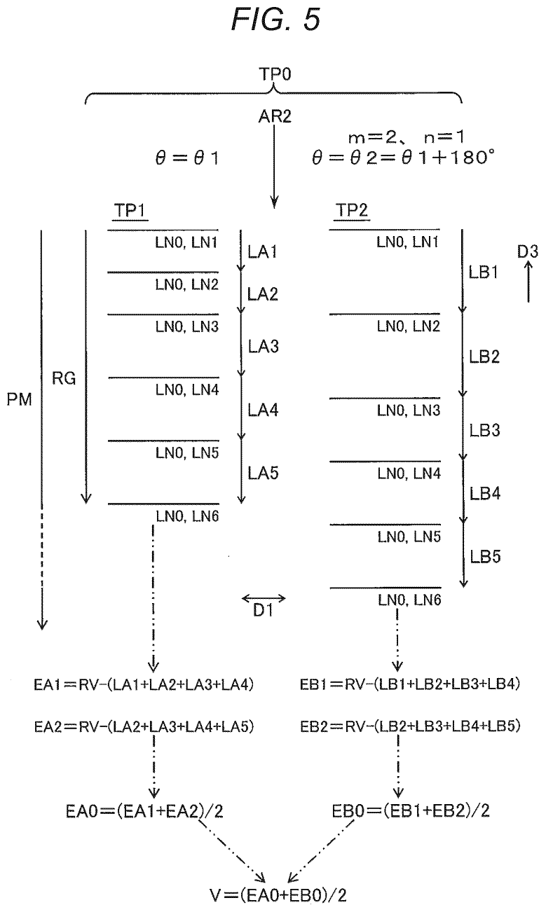

As illustrated in FIG. 5, m=2 and n=1 may be used. That is, the control unit U1 may perform the second control (S108 to S112) of forming the second test pattern TP2 in the cantilevered print area AR2 in the state where the rotary element (53) is in a phase based on the second phase (θ2) shifted by ½ cycles from the first phase (θ1) as a reference.

In the above case, since the number of test patterns to be printed is small, for example, the number of times the medium ME1 is resupplied or back-fed to the conveyance path is small and therefore the test pattern group can be printed in a short time.

### Aspect 3

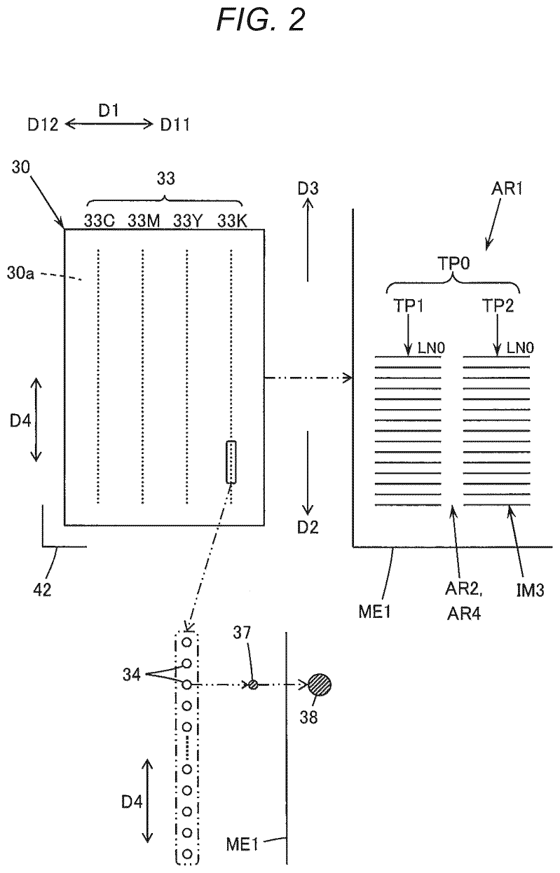

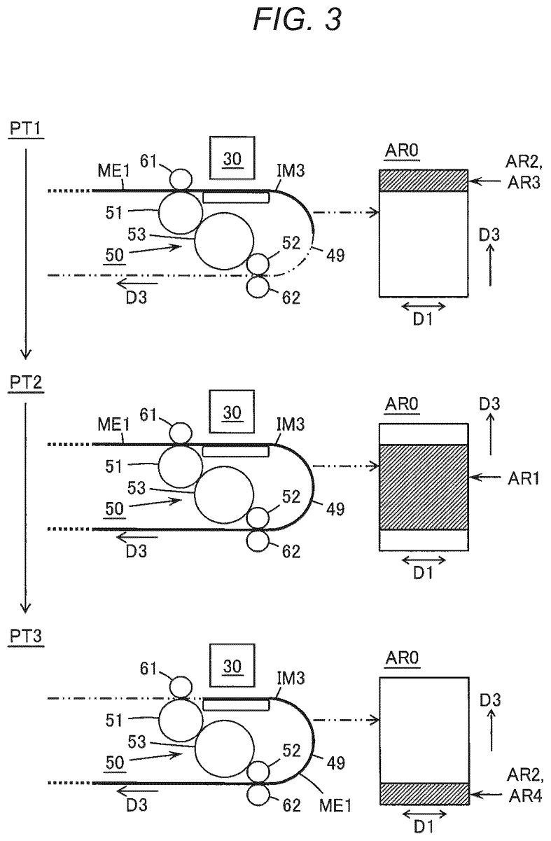

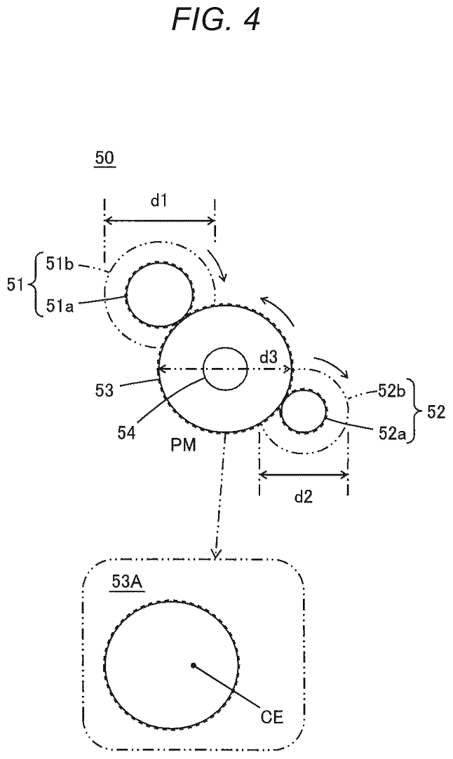

As illustrated in FIG. 4 and the like, the downstream drive roller 52 may have a smaller diameter than the upstream drive roller 51. As illustrated in FIGS. 2 and 3 and the like, the cantilevered print area AR2 may include a lower-end print area AR4 where the medium ME1 is conveyed by the rotation of the downstream drive roller 52 in the state where the upstream drive roller 51 is separated from the medium. The control unit U1 may perform the first control (S102 to S106) for forming the first test pattern TP1 in the lower-end print area AR4 and the second control (S108 to S112) for forming the second test pattern TP2 in the lower-end print area AR4.

The upstream drive roller 51 needs to have higher conveyance accuracy than the downstream drive roller 52 in order to accurately position the medium ME1 when conveying the medium between main scans. As the diameter of the roller increases, the contact area between the roller and the medium ME1 increases and the stability of conveyance is improved, and therefore the upstream drive roller 51 generally has a larger diameter than the downstream drive roller 52. When the medium ME1 is conveyed only by the downstream drive roller 52 having a smaller diameter, the conveyance error increases, and therefore determining the adjustment value V based on the printing position of each test pattern printed in the lower-end print area AR4 achieves a large effect in adjusting the amount of conveyance. Thus, the above aspect can provide a preferable example of printing a test pattern group.

### Aspect 4

As illustrated in FIG. 5 and the like, the first test pattern TP1 and the second test pattern TP2 may be a pitch line group in which a plurality of lines LN0 along the main scanning direction D1 are arranged at intervals in the conveyance direction D3.

In the above case, since the adjustment value V can be calculated from the plurality of lines LN0, a printing device that can print a test pattern group useful for acquiring an adjustment value with higher accuracy can be provided.

### Aspect 5

As illustrated in FIG. 5, a range RG of the pitch line group in the conveyance direction D3 may be equal to or less than a designed circumferential length PM of the rotary element (53).

Since the first test pattern TP1 based on the first phase (θ1) as a reference and the second test pattern TP2 based on the second phase (θ2) as a reference are formed in the cantilevered print area AR2 even when the range RG of the pitch line group in the conveyance direction D3 is equal to or less than the designed circumferential length PM of the rotary element (53), the adjustment value V can be calculated regardless of the relationship between the designed circumferential length PM of the rotary element (53) and the diameter of the downstream drive roller 52 or the upstream drive roller 51. For example, when the designed circumferential length PM of the rotary element (53) is longer than the downstream drive roller 52, a test pattern for one circumference of the rotary element (53) cannot be formed in an area where the medium is conveyed in a cantilever manner only by the downstream drive roller, but when the range RG of the pitch line group is made smaller than the circumferential length of the rotary element (53) and the test pattern is divided into the first test pattern TP1 and the second test pattern TP2, a printing device that can print a test pattern group that enables the calculation of the adjustment value V regardless of the size of each member of the conveyance unit can be provided.

### Aspect 6

As illustrated in FIG. 6, an amount-of-conveyance adjustment method for the printing device 1 according to an aspect includes the following steps.

(b1) A first process ST1 of forming the first test pattern TP1 in the cantilevered print area AR2 in the state where the rotary element (53) is in a phase based on the first phase (θ1) as a reference. (b2) A second process ST2 of forming the second test pattern TP2 in the cantilevered print area AR2 in the state where the phase of the rotary element (53) is a phase based on one or more second phases (θ2) shifted from the first phase (θ1) by k(n/m) cycles as a reference, where m is an integer of 2 or more, n is an integer of 1 or more and less than m, and k is all integers from 1 to m−1.

(b3) A third process ST3 of adjusting the amount of conveyance, based on the first test pattern TP1 and the one or more second test patterns TP2.

In the above aspect, too, the first test pattern TP1 is printed in the cantilevered print area AR2 in the state where the rotary element (53) is in a phase based on the first phase (θ1) as a reference, and the second test pattern TP2 is printed in the cantilevered print area AR2 in the state where the rotary element (53) is in a phase based on the one or more second phases (θ2) shifted from the first phase (θ1) by k(n/m) cycles as a reference. As the amount of conveyance of the medium ME1 is adjusted, based the first test pattern TP1 and the one or more second test patterns TP2, the conveyance error depending on the phase of the rotary element (53) is reduced. Thus, according to the above aspect, an amount-of-conveyance adjustment method that reduces a conveyance error occurring in an area at an end part in the conveyance direction, of a print area on the medium, can be provided.

Moreover, the above-described aspect can be applied to a printing system including the above-described printing device, a control method for the above-described printing device, a control program for the above-described printing device, a computer-readable non-transitory medium in which the control program is recorded, and the like. The above-described printing device may include a plurality of distributed parts.

### (2) Specific Example of Printing Device

FIG. 1 schematically illustrates the printing device 1. The printing device 1 in this specific example is a printer 2 itself, but the printing device 1 may be a combination of the printer 2 and a host device HO1. The printer 2 may include a reading unit 19 that reads the print image IM3, or may include an additional element that is not shown in FIG. 1. The reading unit 19 may be coupled to the printer 2 as an external device. FIG. 2 schematically illustrates the recording head 30 and the print image IM3. FIG. 3 schematically illustrates upper-end printing, double-supported printing, and lower-end printing.

The printer 2 shown in FIG. 1 is an inkjet printer that ejects a liquid 36 including an ink, as droplets 37, and is a serial printer that repeats a main scan and a sub scan. The concept of the liquid 36 includes an ink containing a coloring material, a treatment liquid that reacts with the coloring material of the ink, a solution that improves image quality, and the like. The ink in a broad sense includes the treatment liquid and the solution described above. The droplets of the ink are referred to as ink droplets. The printer 2 includes a controller 10, a random access memory (RAM) 21, which is a semiconductor memory, a communication interface (I/F) 22, a storage unit 23, an operation panel 24, the recording head 30, the main scanning unit 40, the conveyance unit 50, the reading unit 19, and the like. The controller 10 is an example of the control unit U1. The control unit U1 may be a combination of the controller 10 and the host device HO1. The controller 10, the RAM 21, the communication I/F 22, the storage unit 23, and the operation panel 24 are coupled to a bus and can input and output information to and from each other.

The controller 10 includes a central processing unit (CPU) 11, which is a processor, a color conversion unit 12, a halftone processing unit 13, a rasterization processing unit 14, a drive signal transmission unit 15, and the like. The controller 10 controls the ejection of the droplets 37 by the recording head 30, the main scan by the main scanning unit 40, and the conveyance of the medium ME1 by the conveyance unit 50, based on the image IM1 acquired from any one of the host device HO1, a memory card, not illustrated, and the like. It can be said that the controller 10 controls the operations of the recording head 30, the main scanning unit 40, and the conveyance unit 50 such that the print image IM3 corresponding to the image IM1 is formed on the medium ME1. For example, an RGB image represented by RGB data having integer values of 2⁸ tones (or 2¹⁶ tones or the like) of R (red), G (green), and B (blue) for each pixel can be applied to the image IM1.

The controller 10 can be configured with a system on a chip (SoC) or the like.

The CPU 11 is a device that mainly performs information processing and control in the printer 2.

The color conversion unit 12 refers to, for example, a color conversion lookup table (LUT) in which a correspondence relationship between tone values of R, G, and B and tone values of C (cyan), M (magenta), Y (yellow), and K (black) is defined, and converts RGB data representing the image IM1 into amount-of-ink data DA1. The amount-of-ink data DA1 has, for example, integer values of 2⁸ tones (or 2¹² tones) of C, M, Y, and K for each pixel. The amount-of-ink data DA1 represents the amount of use of the liquid 36 of C, M, Y, and K on a pixel basis. When the resolution of the RGB data is different from the print resolution, the color conversion unit 12 first converts the resolution of the RGB data into the print resolution or converts the resolution of the amount-of-ink data DA1 into the print resolution.

The halftone processing unit 13 performs halftone processing on the tone value of each pixel forming the amount-of-ink data DA1 by any one of a dither method, an error diffusion method, and the like, thus reduces the number of tones of the tone value, and generates dot data DA2. The dot data DA2 represents the formation state of dots 38 of the droplets 37 on a pixel basis. The dot data DA2 may be binary data representing whether to form dots, or may be multi-level data of three or more tones that can correspond to dots of different sizes such as small, medium, and large dots.

The rasterization processing unit 14 performs rasterization processing of rearranging the dot data DA2 in the order in which the dots 38 are formed at the time of printing, and thus generates raster data DA3.

The drive signal transmission unit 15 generates a drive signal SG1 from the raster data DA3 and outputs the drive signal SG1 to a drive circuit 31 of the recording head 30. The drive signal SG1 corresponds to a voltage signal applied to a drive element 32 of the recording head 30. For example, when the raster data DA3 indicates that “dots are to be formed”, the drive signal transmission unit 15 outputs the drive signal SG1 for ejecting droplets for forming the dots. When the raster data DA3 is data having three or more values, the drive signal transmission unit 15 outputs the drive signal SG1 for ejecting droplets for large dots when the raster data DA3 indicates that “large dots are to be formed”, and outputs the drive signal SG1 for ejecting droplets for small dots when the raster data DA3 indicates that “small dots are to be formed”. The print image IM3 is formed on the medium ME1 according to the drive signal SG1.

The above-described elements (11 to 15) may be configured with an application-specific integrated circuit (ASIC), and may directly read processing target data from the RAM 21 or directly write processed data to the RAM 21.

The main scanning unit 40 controlled by the controller 10 includes a carriage drive unit 41 including a servo motor, a carriage 42 in which the recording head 30 is mounted, and a long guide 43 whose longitudinal direction is oriented in the main scanning direction D1. The main scanning unit 40 moves the carriage 42 forward and backward along the main scanning direction D1 by driving the carriage drive unit 41 under the control of the controller 10. It can be said that the main scanning unit 40 moves the recording head 30 along the main scanning direction D1. The conveyance unit 50 controlled by the controller 10 includes an upstream roller pair (51, 61), a downstream roller pair (52, 62), a spur gear 53 as an example of a rotary element, and a drive source 54 such as a servo motor. The upstream roller pair includes the upstream drive roller 51 and an upstream driven roller 61, and is located upstream of the recording head 30 in the conveyance direction D3. Being located upstream of the recording head 30 means being at a position toward the recording head 30 in a conveyance path 49. The downstream roller pair includes the downstream drive roller 52 and a downstream driven roller 62, and is located downstream of the recording head 30 in the conveyance direction D3. Being located downstream of the recording head 30 means being at a position away from the recording head 30 in the conveyance path 49. The conveyance unit 50 rotates the drive rollers (51, 52) under the control of the controller 10 and thus conveys the medium ME1 in the conveyance direction D3 along the conveyance path 49. Although the conveyance path 49 illustrated in FIG. 1 is curved, the conveyance path 49 may be a straight path. A platen 48 in the conveyance path 49 comes into contact with the medium ME1 and thus supports the medium ME1.

As illustrated in FIG. 2, the main scanning direction D1 is a direction intersecting a nozzle arrangement direction D4 of nozzles 34 in a nozzle row 33, and is, for example, a direction orthogonal to the nozzle arrangement direction D4. In FIG. 2, the right direction is a forward direction D11 of the main scan, and the left direction is a backward direction D12 of the main scan. The carriage 42 is fixed to an endless belt, not illustrated, and is movable in the forward direction D11 and the backward direction D12 along the guide 43. The conveyance direction D3 is a direction intersecting the main scanning direction D1, and is, for example, a direction orthogonal to the main scanning direction D1. When the conveyance unit 50 intermittently feeds the medium ME1 in the conveyance direction D3, the conveyance direction D3 can also be referred to as a feeding direction. A sub scanning direction D2 is a direction opposite to the conveyance direction D3.

At the time of the main scan, the controller 10 controls the main scanning unit 40 to move the recording head 30 along the main scanning direction D1 and controls the recording head 30 to eject the droplets 37 from the nozzle row 33. At the time of the sub scan between the main scans, the controller 10 controls the conveyance unit 50 to feed the medium ME1 in the conveyance direction D3 by a predetermined distance. The printer 2 repeats the main scan and the sub scan and thus forms the print image IM3 including the test pattern group TP0 on the medium ME1. The medium ME1 is a printed object that holds a print image. The material of the medium ME1 is not particularly limited, and various materials such as paper, resin, and metal are conceivable. The shape of the medium ME1 is not particularly limited, either, and various shapes such as a rectangular shape and a roll shape are conceivable, and the medium ME1 may have a three-dimensional shape.

The recording head 30 illustrated in FIG. 2 includes, at a nozzle surface 30a, a plurality of nozzle rows 33 in which a plurality of nozzles 34 that can eject the droplets 37 onto the medium ME1 are arranged at an interval that is a predetermined nozzle pitch, in the nozzle arrangement direction D4. The nozzle refers to a small hole through which liquid droplets are ejected, and the nozzle row refers to an array of a plurality of nozzles. The nozzle surface 30a is an ejection surface of the droplets 37. The plurality of nozzles 34 in each nozzle row 33 may be arranged in a staggered form in the nozzle arrangement direction D4, that is, in two rows in the nozzle arrangement direction D4. The plurality of nozzle rows 33 include a C nozzle row 33C that can eject a C ink as the liquid 36, an M nozzle row 33M that can eject an M ink as the liquid 36, a Y nozzle row 33Y that can eject a Y ink as the liquid 36, and a K nozzle row 33K that can eject a K ink as the liquid 36. Each droplet 37 is ejected from the nozzle 34 to the medium ME1, taking a pixel as a target. Of course, a C dot 38 is formed on the medium ME1 by a C droplet 37, an M dot 38 is formed on the medium ME1 by an M droplet 37, a Y dot 38 is formed on the medium ME1 by a Y droplet 37, and a K dot 38 is formed on the medium ME1 by a K droplet 37. The printer 2 may include a plurality of recording heads 30.

The drive circuit 31 of the recording head 30 applies a voltage signal to the drive element 32 according to the drive signal SG1 input from the drive signal transmission unit 15. The drive element 32 may be a piezoelectric element that applies pressure to the liquid 36 in a pressure chamber communicating with the nozzle 34, or may be a drive element or the like that generates air bubbles in the pressure chamber by heat and ejects the liquid droplets 37 from the nozzle 34. The liquid 36 is supplied to the pressure chamber of the recording head 30 from a liquid supply unit 35 such as an ink cartridge or an ink tank. The liquid 36 in the pressure chamber is ejected as the droplets 37 from the nozzle 34 toward the medium ME1 by the drive element 32. Thus, the dots 38 of the droplets 37 are formed on the medium ME1, and the print image IM3 expressed by the pattern of the dots 38 is formed on the medium ME1. The printer 2 may perform bidirectional printing in which the print image IM3 is formed by both the main scan in the forward direction D11 and the main scan in the backward direction D12, or may perform unidirectional printing in which the print image IM3 is formed by only one of the main scan in the forward direction D11 and the main scan in the backward direction D12.

The RAM 21 stores an image IM1 or the like accepted from the host device HO1, a memory, not illustrated, or the like. The communication I/F 22 is connected to the host device HO1 via a wire or wirelessly, and inputs and outputs information from and to the host device HO1. The host device HO1 includes a computer such as a personal computer or a tablet terminal, a mobile phone such as a smartphone, a digital camera, a digital video camera, and the like. The storage unit 23 may be a nonvolatile semiconductor memory such as a flash memory, a magnetic storage device such as a hard disk, or the like. The operation panel 24 includes an output unit 25 such as a liquid crystal panel that displays information, an input unit 26 such as a touch panel that accepts an operation on a display screen, and the like.

The reading unit 19 may be a solid-state image pickup element such as a line sensor or an area sensor configured with a charge coupled device (CCD), a complementary metal-oxide semiconductor (CMOS) image sensor, a contact image sensor (CIS) type or CCD type image sensor, or the like. The reading unit 19 in this specific example includes an analog/digital converting circuit that converts an analog amount of the detection voltage of each pixel into a digital value, converts an analog density amount corresponding to each detection voltage into a digital density value by the analog/digital conversion circuit, and outputs the digital density value to the controller 10.

As illustrated in FIG. 3, the conveyance unit 50 rotates at least one of the upstream drive roller 51 and the downstream drive roller 52 in contact with the medium ME1 and thus conveys the medium ME1 in the conveyance direction D3. Thus, upper-end printing PT1 is performed in the state where the downstream drive roller 52 is separated from the medium ME1, then, double-supported printing PT2 is performed in the state where both of the drive rollers (51, 52) are in contact with the medium, and finally, lower-end printing PT3 is performed in the state where the upstream drive roller 51 is separated from the medium ME1. The print area AR0 on the medium ME1 is divided into an upper-end print area AR3 where the upper-end printing PT1 is performed, a double-supported print area AR1 where the double-supported printing PT2 is performed, and a lower-end print area AR4 where the lower-end printing PT3 is performed. Of course, the double-supported print area AR1 is located between the upper-end print area AR3 and the lower-end print area AR4 in the conveyance direction D3. The upper-end print area AR3 is an area where the medium ME1 is conveyed by the rotation of the upstream drive roller 51 in the state where the downstream drive roller 52 is separated from the medium. The lower-end print area AR4 is an area where the medium ME1 is conveyed by the rotation of the downstream drive roller 52 in the state where the upstream drive roller 51 is separated from the medium. The upper-end print area AR3 and the lower-end print area AR4 are cantilevered print areas AR2 where the medium ME1 is conveyed in the state where one of the upstream drive roller 51 and the downstream drive roller 52 is separated from the medium.

FIG. 4 schematically illustrates the structure of the conveyance unit 50.

The upstream drive roller 51 includes a first gear 51a coaxial with a main body 51b in contact with the medium ME1, and is located upstream of the recording head 30 in the conveyance direction D3. The downstream drive roller 52 includes a second gear 52a coaxial with a main body 52b in contact with the medium ME1, and is located downstream of the recording head 30 in the conveyance direction D3. Although the gears (51a, 52a) shown in FIG. 4 are spur gears, the gears (51a, 52a) may be bevel gears, helical gears, or the like. The diameter d1 of the main body 51b of the upstream drive roller 51 is larger than the diameter d2 of the main body 52b of the downstream drive roller 52. This is because the upstream drive roller 51 needs to have higher conveyance accuracy than the downstream drive roller 52 in order to accurately position the medium ME1 conveyed at the time of the sub scan. The first gear 51a has a larger diameter than the second gear 52a in order to substantially equalize the speeds of the parts in contact with the medium ME1, of the upstream drive roller 51 and the downstream drive roller 52. The spur gear 53 meshes with the first gear 51a and the second gear 52a. The diameter d3 of the spur gear 53 shown in FIG. 4 is larger than the diameter of the gears (51a, 52a). The drive source 54 illustrated in FIG. 4 directly rotates the spur gear 53 and consequently indirectly rotates the upstream drive roller 51 including the first gear 51a and the downstream drive roller 52 including the second gear 52a. That is, the rotational driving force from the drive source 54 is transferred to the upstream drive roller 51 and the downstream drive roller 52 via the spur gear 53. FIG. 4 shows that the drive source 54 rotates the spur gear 53 counterclockwise and consequently causes the upstream drive roller 51 and the downstream drive roller 52 to rotate clockwise. A servo motor that operates under the control of the controller 10 can be used as the drive source 54.

The drive source 54 may directly rotate the upstream drive roller 51 or the downstream drive roller 52. When the drive source 54 directly rotates the upstream drive roller 51, the rotational driving force from the drive source 54 is transferred to the downstream drive roller 52 via the first gear 51a and the spur gear 53. When the drive source 54 directly rotates the downstream drive roller 52, the rotational driving force from the drive source 54 is transferred to the upstream drive roller 51 via the second gear 52a and the spur gear 53.

It is conceivable that a “conveyance roller error” occurs in the amount of conveyance of the medium ME1 at the time of each sub scan due to the eccentricity of the drive rollers (51, 52) in contact with the medium ME1, the cross-sectional shape of the drive roller that is not a perfect circle, or the like. Therefore, as disclosed in JP-A-2024-51459, a test pattern group for eliminating the influence of the “conveyance roller error” as much as possible is printed, and the amount of conveyance of the medium ME1 is thus adjusted. However, it is found that, even when the adjustment value for suppressing the “conveyance roller error” is set in the printer 2, density unevenness, for example, a light streak such as a white streak or a dark streak such as a black streak, occurs in an area at an end part in the conveyance direction D3, of the print area AR0. These streaks are also called banding.

As a result of a test, it is found that density unevenness considered to depend on the rotation angle of the spur gear 53 instead of the drive rollers (51, 52) occurs in the upper-end print area AR3 and the lower-end print area AR4, that is, in the cantilevered print area AR2. In the double-supported print area AR1, where the medium ME1 is conveyed in the state where both the upstream drive roller 51 and the downstream drive roller 52 are in contact with the medium, the above-described density unevenness is not confirmed.

As the reason why the above-described density unevenness occurs only in the cantilevered print area AR2, the following is conceivable, though it is a presumption.

The spur gear 53 may have a manufacturing error such as eccentricity or a cross-sectional shape that is not a perfect circle. A spur gear 53A whose center CE is shifted is shown in an area surrounded by a two-dot chain line in FIG. 4. It is conceivable that, due to such a manufacturing error, density unevenness depending on the rotation angle of the spur gear 53 occurs in the cantilevered print area AR2, where circumferential speed of the spur gear 53 is directly transferred to the drive rollers (51, 52). The position where the spur gear 53 meshes with the first gear 51a and the position where the spur gear 53 meshes with the second gear 52a are different. For this reason, it is conceivable that, in the double-supported print area AR1, the error in the amount of conveyance appearing via the upstream drive roller 51 and the error in the amount of conveyance appearing via the downstream drive roller 52 due to the eccentricity of the spur gear 53 or the like cancel each other to some extent. Since the error depending on the rotation angle of the spur gear 53 is offset to some extent in this manner, it is presumed that the above-described density unevenness is not confirmed.

In this specific example, in order to suppress the above-described density unevenness, the test pattern group TP0 including the first test pattern TP1 and the second test pattern TP2 is printed in the cantilevered print area AR2, as shown in FIG. 2. The first test pattern TP1 and the second test pattern TP2 are printed in a state where the rotation angle of the spur gear 53 is different by a predetermined angle. Details thereof will be described below.

FIG. 5 schematically illustrates how the adjustment value V is calculated from the test patterns (TP1, TP2). To facilitate understanding, in FIG. 5, the conveyance error is exaggerated on the assumption that one line LN0 along the main scanning direction D1 is printed in the cantilevered print area AR2 by the droplets 37 ejected from the predetermined nozzle 34 every time the spur gear 53 rotates less than 72°, for example, 30°.

After controlling the rotation angle θ of the spur gear 53, the controller 10 performs control for ejecting the droplets 37 from the predetermined nozzle 34 of the recording head 30 moving along the main scanning direction D1 to the cantilevered print area AR2, and thus printing the line LN0. It can be said that the test patterns (TP1, TP2) are pitch line groups in which a plurality of lines LN0 along the main scanning direction D1 are arranged at intervals in the conveyance direction D3. In this example, six lines LN0 of each pitch line group are referred to as lines LN1 to LN6. The same “predetermined nozzle 34” is used to form the lines LN1 to LN6.

For the first test pattern TP1 shown in FIG. 5, the controller 10 performs the first control for forming the first test pattern TP1 in the cantilevered print area AR2 in a state where the spur gear 53 is at a rotation angle based on the first angle θ1 as a reference. The first angle θ1 is an example of the first phase. The controller 10 sets the first angle θ1 as the initial angle of the spur gear 53, causes the droplets 37 to be ejected from the predetermined nozzle 34 of the recording head 30 moving along the main scanning direction D1, and thus causes the line LN1 to be printed in the cantilevered print area AR2. Next, the controller 10 causes the spur gear 53 to rotate 30°, causes the droplets 37 to be ejected from the predetermined nozzle 34 of the recording head 30 moving along the main scanning direction D1, and thus causes the line LN2 to be printed in the cantilevered print area AR2. The amount of conveyance LA1 of the medium ME1 by the rotation of the spur gear 53 at this time is the distance between the line LN1 and the line LN2 in the conveyance direction D3. Next, the controller 10 causes the spur gear 53 to rotate 30° and causes the line LN3 to be printed in the cantilevered print area AR2 by similar droplet ejection. The amount of conveyance LA2 at this time is the distance between the line LN2 and the line LN3. Next, the controller 10 causes the spur gear 53 to rotate 30° and causes the line LN4 to be printed in the cantilevered print area AR2 by similar droplet ejection. The amount of conveyance LA3 at this time is the distance between the line LN3 and the line LN4. Next, the controller 10 causes the spur gear 53 to rotate 30° and causes the line LN5 to be printed in the cantilevered print area AR2 by similar droplet ejection. The amount of conveyance LA4 at this time is the distance between the line LN4 and the line LN5. If there is no conveyance error at this point in time, the sum of the amounts of conveyance LA1 to LA4 is a predetermined reference value RV. The reference value RV can be set, for example, according to an ideal value (α) when there is no error occurring in the interval between a predetermined pitch line and a pitch line adjacent thereto, and in the example shown in FIG. 5, the reference value RV is 4α. Finally, the controller 10 causes the spur gear 53 to rotate 30° and causes the line LN6 to be printed in the cantilevered print area AR2 by similar droplet ejection. The amount of conveyance LA5 at this time is the distance between the line LN5 and the line LN6. The range RG of the pitch line group (LN1 to LN6) in the conveyance direction D3 is equal to or less than the designed circumferential length PM of the spur gear 53.

For the second test pattern TP2 shown in FIG. 5, the controller 10 performs the second control for forming the second test pattern TP2 in the cantilevered print area AR2 in a state where the spur gear 53 is at a rotation angle based on the second angle θ2 shifted from the first angle θ1 by ½ cycles, that is, by 180,° as a reference. The second angle θ2 is an example of the second phase. The controller 10 sets the second angle θ2 as the initial angle of the spur gear 53, causes the droplets 37 to be ejected from the predetermined nozzle 34 of the recording head 30 moving along the main scanning direction D1, and thus causes the line LN1 to be printed in the cantilevered print area AR2. Next, the controller 10 causes the spur gear 53 to rotate 30°, causes the droplets 37 to be ejected from the predetermined nozzle 34 of the recording head 30 moving along the main scanning direction D1, and thus causes the line LN2 to be printed in the cantilevered print area AR2. The amount of conveyance LB1 of the medium ME1 by the rotation of the spur gear 53 at this time is the distance between the line LN1 and the line LN2 in the conveyance direction D3. Subsequently, the controller 10 causes the spur gear 53 to rotate 30° each and causes the lines LN3, LN4, LN5, LN6 to be printed in the cantilevered print area AR2 by similar droplet ejection. FIG. 5 also shows the amount of conveyance LB2 between the line LN2 and the line LN3, the amount of conveyance LB3 between the line LN3 and the line LN4, the amount of conveyance LB4 between the line LN4 and the line LN5, and the amount of conveyance LB5 between the line LN5 and the line LN6. The range RG of the pitch line group (LN1 to LN6) in the conveyance direction D3 is equal to or less than the designed circumferential length PM of the spur gear 53.

It is assumed that the amounts of conveyance LA1 to LA5 for the first test pattern TP1 are reduced as a whole due to the eccentricity of the spur gear 53 as illustrated in FIG. 5. In this case, since the reference of the rotation angle θ for the second test pattern TP2 is different from the reference of the rotation angle θ for the first test pattern TP1 by 180°, the change in the amount of conveyance tends to be shifted from that of the first test pattern TP1 by 180°. FIG. 5 shows that the amounts of conveyance LB1 to LB5 are large as a whole for the second test pattern TP2.

Therefore, in this specific example, both the amounts of conveyance LA1 to LA5 for the first test pattern TP1 and the amounts of conveyance LB1 to LB5 for the second test pattern TP2 are reflected in the adjustment value V. Thus, the adjustment value V in which the conveyance error caused by the rotation angle θ of the spur gear 53, in particular, the conveyance error caused by the eccentricity of the spur gear 53 is canceled is obtained, and the conveyance error generated in the cantilevered print area AR2 at the end part in the conveyance direction D3, of the print area AR0, can be reduced.

FIG. 5 illustrates an example in which the adjustment value V is calculated using the differences between the reference value RV and the corresponding amount of conveyances as individual errors EA1, EA2, EB1, and EB2. As described above, the reference value RV is a value determined based on the interval α in each pitch line group, and is 4α in the example shown in FIG. 5. For the first test pattern TP1, the first individual error EA1 is 4α−(LA1+LA2+LA3+LA4) and the second individual error EA2 is 4α−(LA2+LA3+LA4+LA5). The average error EA0 is (EA1+EA2)/2. For the second test pattern TP2, the first individual error EB1 is 4α−(LB1+LB2+LB3+LB4) and the second individual error EB2 is 4α−(LB2+LB3+LB4+LB5). The average error EB0 is (EB1+EB2)/2. As the average value (EA0+EB0)/2 of these errors EA0 and EB0 is set to the adjustment value V, the conveyance error caused by the rotation angle θ of the spur gear 53 is canceled and the conveyance error occurring in the cantilevered print area AR2 is reduced.

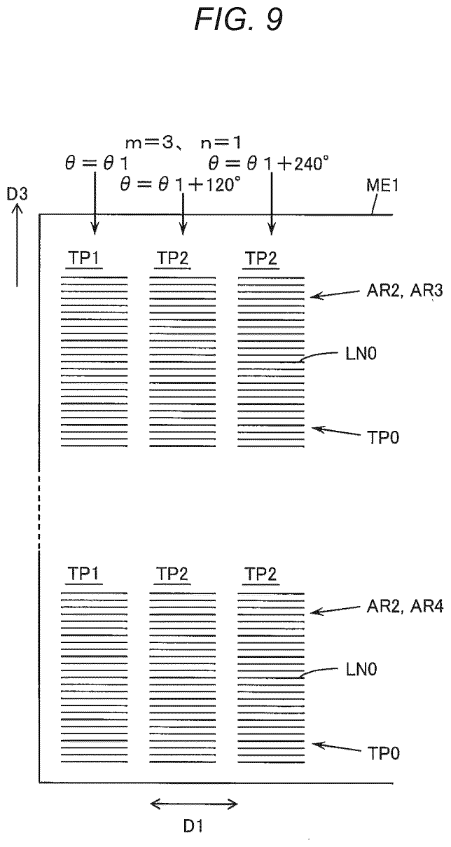

Now, in order to describe the second control in general terms, it is assumed that m is an integer of 2 or more, n is an integer of 1 or more and less than m, and k is all integers from 1 to m−1. To generalize the description, a case where the cycle of the spur gear is larger than one cycle is also described, and thus pitch line groups shifted such that the cycle of the spur gear is larger than one cycle are formed, and therefore the number of pitch line groups to be formed can be increased and the adjustment value V with higher accuracy can be acquired. The controller 10 performs the second control for forming the second test pattern TP2 in the cantilevered print area AR2 in a state where the spur gear 53 is at a rotation angle based on one or more second angles θ2 shifted from the first angle θ1 by k(n/m) cycles as a reference. In the example shown in FIG. 5, since m=2 and n=1, k is only 1, and k(n/m) cycles is ½ cycles, that is, 180°. As will be described in detail later, if m=3 and n=1 as illustrated in FIG. 9, k is 1 and 2, and k(n/m) cycles is ⅓ cycles and ⅔ cycles, that is, 120° and 240°. In this case, as the second test pattern TP2, a pitch line group based on θ2=θ1+120° and a pitch line group based on θ2=θ1+240° are printed in the cantilevered print area AR2. If m=5 and n=2, k is 1, 2, 3, and 4, and k(n/m) cycles is 2/5 cycles, ⅘ cycles, 6/5 cycles, and 8/5 cycles. In this case, as the second test pattern TP2, a pitch line group based on θ2=θ1+144°, a pitch line group based on θ2=θ1+288°, a pitch line group based on θ2=θ1+432°, and a pitch line group based on θ2=θ1+576° are printed in the cantilevered print area AR2.

The number of lines LN0 provided in the test patterns (TP1, TP2) is not limited to 6, and may be 2 to 5, or 7 or more. The rotation angle of the spur gear 53 between the lines LN0 is not limited to 90°, and may be less than 90° or greater than 90°. If the rotation angle of the spur gear 53 between the lines LN0 is reduced and the number of lines LN0 provided in the test patterns (TP1, TP2) is increased, the adjustment value V can be calculated from more lines LN0 and a more accurate adjustment value V can be obtained. For example, it is assumed that the rotation angle of the spur gear 53 between the lines LN0 is 5° and each of TP1 and TP2 is formed to have 25 pitch lines. In this case, TP1 is formed while the spur gear 53 rotates in the range of θ1 to θ1+120°, and TP2 is formed while the spur gear 53 rotates in the range of θ1+180° to θ1+180°+120°, that is, the range of θ1+180° to θ1+300 °.

The reference value RV is not limited to 4α, which is an interval of five pitch lines, and may be α to 3α, or 5α or more. For example, when each of TP1 and TP2 has 25 pitch lines as described above, EA1=RV-(LA1+LA2+. . . +LA14) holds, where 14α, which is the average of 15 pitch lines, is set as the reference value RV. The same applies to EB. In this case, since EA and EB can be calculated from EA1 to EA11 and EB1 to EB11, respectively, an average error is obtained from 11 individual errors and a more accurate adjustment value V is obtained.

As long as the amount of conveyance can be acquired, two or more lines LN0 of the plurality of lines LN0 provided in the test patterns (TP1, TP2) may be formed in the cantilevered print area AR2 by one main scan.

### (3) Specific Example of Amount-of-Conveyance Adjustment Processing

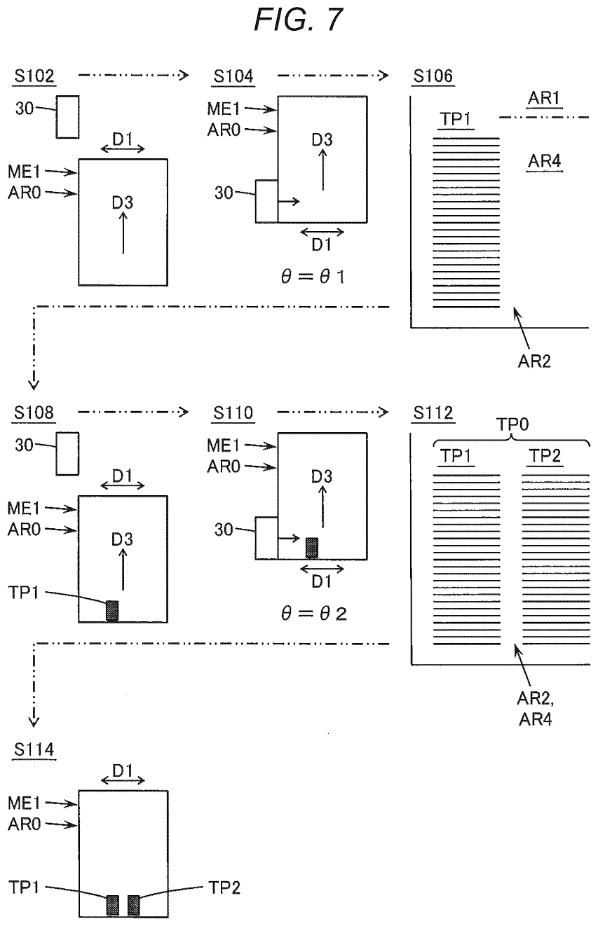

FIG. 6 schematically illustrates amount-of-conveyance adjustment processing performed by the control unit U1 shown in FIG. 1. Here, steps S102 to S106 correspond to the first process ST1 and the first control, steps S108 to S112 correspond to the second process ST2 and the second control, and steps S114 to S116 correspond to the third process ST3. Hereinafter, the description of “step” may be omitted, and the reference characters of the steps may be shown in parentheses. FIG. 7 schematically illustrates a state where the test pattern group TP0 for acquiring the adjustment value V of the amount of conveyance of the medium ME1 is printed according to the flow shown in FIG. 6.

The controller 10 as the control unit U1 may perform at least the processing of S102 to S112 and perform the processing of S114 and S116. The processing of S114 and S116 may be performed by the host device HO1 as the control unit U1. The amount-of-conveyance adjustment processing starts when the controller 10 receives a print instruction for the test pattern group TP0. The print instruction may be an instruction caused by a print request from the host device HO1 to the printer 2, an instruction caused by a print start operation on the input unit 26 of the printer 2, or the like.

It is assumed that the controller 10 prints the test pattern group TP0 in which the rotation angle θ of the spur gear 53 is shifted by 180° between the first test pattern TP1 and the second test pattern TP2, in the lower-end print area AR4. The first test pattern TP1 and the second test pattern TP2 are printed side by side in the main scanning direction D1.

As the amount-of-conveyance adjustment processing starts, the controller 10 controls the rotation angle θ of the spur gear 53 so as to be the first angle θ1 at the print start position of the first test pattern TP1 in the lower-end print area AR4, for example, the position of the line LN1 shown in FIG. 5 (S102). When the medium ME1 is supplied to the conveyance path 49 shown in FIG. 1, the medium ME1 is nipped by the upstream roller pair (51, 61) and conveyed in the conveyance direction D3, and is then nipped by the downstream roller pair (52, 62) and conveyed in the conveyance direction D3. Therefore, the controller 10 may perform control for idling the drive rollers (51, 52) so that the rotation angle θ of the spur gear 53 at the time when the medium ME1 is nipped by the upstream roller pair (51, 61) becomes the first angle θ1 at the above-described print start position.

After the processing of S102, the controller 10 performs control for conveying the medium ME1 in the conveyance direction D3 to the print start position, and controls the rotation angle θ of the spur gear 53 so as to be the first angle θ1, as shown in FIG. 7 (S104). With reference to the example illustrated in FIG. 5, the medium ME1 is conveyed and the rotation angle θ of the spur gear 53 becomes the first angle θ1 such that the droplets 37 ejected from the predetermined nozzle 34 of the recording head 30 land at the position of the line LN1 in the lower-end print area AR4.

After the processing of S104, the controller 10 performs control for moving the recording head 30 along the main scanning direction D1, then ejecting the droplets 37 from the predetermined nozzle 34, and thus printing the first test pattern TP1 in the lower-end print area AR4 (S106). With reference to the example shown in FIG. 5, the controller 10 may perform control for printing the line LN1 in the lower-end print area AR4 with the droplets 37 from the predetermined nozzle 34 in the state where the initial angle of the spur gear 53 is the first angle θ1, and then rotating the spur gear 53 by a predetermined angle each and printing the lines LN2, LN3, and the like with the droplets 37 from the predetermined nozzle 34. By the processing of S106, the first test pattern TP1 like the pitch line group shown in FIG. 6 is printed in the lower-end print area AR4 as the cantilevered print area AR2.

As described above, the controller 10 performs the first control for forming the first test pattern TP1 in the cantilevered print area AR2 in the state where the spur gear 53 is at a rotation angle based on the first angle θ1 as a reference.

After the processing of S106, the controller 10 controls the rotation angle θ of the spur gear 53 so as to be the second angle θ2 at the print start position of the second test pattern TP2 in the lower-end print area AR4, for example, the position of the line LN1 shown in FIG. 5 (S108). The second angle θ2 is shifted from the first angle θ1 by 180°. For example, the controller 10 causes the medium ME1 with the first test pattern TP1 formed thereon to be ejected from the conveyance path 49, and controls the rotation angle θ so as to be the second angle θ2 at the above-described print start position of the medium ME1 supplied again to the conveyance path 49. The controller 10 may perform control for idling the drive rollers (51, 52) so that the rotation angle θ of the spur gear 53 at the time when the medium ME1 is nipped by the upstream roller pair (51, 61) becomes the second angle θ2 at the above-described print start position.

Also, it is assumed that the conveyance unit 50 can execute back-feeding of returning the medium ME1 in a back-feeding direction opposite to the conveyance direction D3, and that the meshing between the spur gear 53 and the gears (51a, 52a) of the drive rollers (51, 52) can be canceled. In this case, the controller 10 may perform control for back-feeding the medium ME1 with the first test pattern TP1 formed thereon to the above-described print start position, canceling the meshing between the spur gear 53 and the gears (51a, 52a), rotating the spur gear 53 by 180°, and causing the spur gear 53 and the gears (51a, 52a) mesh with each other.

After the processing of S108, the controller 10 performs control for conveying the medium ME1 in the conveyance direction D3 to the print start position, and controls the rotation angle θ of the spur gear 53 so as to be the second angle θ2, as shown in FIG. 7 (S110). With reference to the example illustrated in FIG. 5, the medium ME1 is conveyed and the rotation angle θ of the spur gear 53 becomes the second angle θ2 such that the droplets 37 ejected from the predetermined nozzle 34 of the recording head 30 land at the position of the line LN1 in the lower-end print area AR4.

After the processing of S110, the controller 10 performs control for moving the recording head 30 along the main scanning direction D1, then ejecting the droplets 37 from the predetermined nozzle 34, and thus printing the second test pattern TP2 beside the first test pattern TP1 in the lower-end print area AR4 (S112). With reference to the example shown in FIG. 5, the controller 10 may perform control for printing the line LN1 in the lower-end print area AR4 with the droplets 37 from the predetermined nozzle 34 in the state where the initial angle of the spur gear 53 is the second angle θ2, and then rotating the spur gear 53 by a predetermined angle each and printing the lines LN2, LN3, and the like with the droplets 37 from the predetermined nozzle 34. By the processing of S112, the second test pattern TP2 like the pitch line group shown in FIG. 6 is printed in the lower-end print area AR4. That is, the test pattern group TP0 including the first test pattern TP1 and the second test pattern TP2 is formed in the lower-end print area AR4 as the cantilevered print area AR2.

As described above, the controller 10 performs the second control for forming the second test pattern TP2 in the cantilevered print area AR2 in a state where the spur gear 53 is at a rotation angle based on one or more second angles θ2 shifted from the first angle θ1 by 180° as a reference.

After the processing of S112, the control unit U1, that is, the controller 10 or the host device HO1, causes the reading unit 19 to read the test pattern group TP0 on the medium ME1 and acquires the read data of the test pattern group TP0 (S114). Finally, the control unit U1 performs processing of detecting each line LN0 of the test pattern (TP1, TP2) from the read data, acquiring the amount of conveyance, for example, the amounts of conveyance LA1 to LA5 and LB1 to LB5 illustrated in FIG. 5, from the pitch line group, calculating the adjustment value V from the amount of conveyance, and applying the adjustment value V to the printer 2 (S116). For example, the control unit U1 calculates the average error EA0 based on the amount of conveyance obtained from the first test pattern TP1, calculates the average error EB0 based on the amount of conveyance obtained from the second test pattern TP2, and calculates the adjustment value V=(EA0+EB0)/2.

As described above, the control unit U1 acquires the adjustment amount V for adjusting the amount of conveyance L (see FIG. 8A) of the medium ME1.

FIG. 8A schematically illustrates how the amount of conveyance L is adjusted when the amount of conveyance L of the medium ME1 is larger than the value before adjustment, for example, the reference value RV. FIG. 8B schematically illustrates how the amount of conveyance L is adjusted when the amount of conveyance L of the medium ME1 is smaller than the value before adjustment, for example, the reference value RV. The storage unit 23 of the printer 2 shown in FIG. 1 can store an adjustment value V, and the conveyance unit 50 conveys the medium ME1 so as to achieve the amount of conveyance adjusted according to the adjustment value V. In FIGS. 8A and 8B, “RV” indicates that the stored value is the reference value RV, and “RV+V” indicates that the amount of conveyance L is adjusted according to the adjustment value V.

In the example shown in FIG. 8A, in the case of “RV”, where the amount of conveyance L is not adjusted, a conveyance error Ei=RV−L is generated. The conveyance error Ei in this case is a negative value and may vary according to the rotation angle θ of the spur gear 53. When the adjustment value V is acquired from the conveyance error Ei in consideration of the rotation angle θ and the adjustment value V is stored in the storage unit 23, the conveyance unit 50 adjusts the amount of conveyance L according to the adjustment value V such that the absolute value of the conveyance error Ei decreases.

In the example illustrated in FIG. 8B, in the case of “RV”, where the amount of conveyance L is not adjusted, the conveyance error Ei=RV−L is a positive value and may vary according to the rotation angle θ of the spur gear 53. When the adjustment value V is acquired from the conveyance error Ei in consideration of the rotation angle θ and the adjustment value V is stored in the storage unit 23, the conveyance unit 50 adjusts the amount of conveyance L according to the adjustment value V such that the absolute value of the conveyance error Ei decreases.

As described above, the control unit U1 adjusts the amount of conveyance L, based on the first test pattern TP1 and the second test pattern TP2.

According to the above-described specific example, since the rotation angle θ of the spur gear 53 is shifted by 180° between the first test pattern TP1 and the second test pattern TP2, the conveyance error caused by the rotation angle θ of the spur gear 53 is canceled by acquiring the adjustment value V based on the first test pattern TP1 and the second test pattern TP2. Therefore, in this specific example, the test pattern group TP0 that is useful for acquiring the adjustment value V for reducing the conveyance error occurring in the cantilevered print area AR2 at the end part in the conveyance direction D3, of the print area AR0 on the medium ME1, can be printed. As a result, the conveyance error occurring in the cantilevered print area AR2 can be reduced. Since the rotation angle θ is shifted by 180° between the first test pattern TP1 and the second test pattern TP2, the number of test patterns to be printed can be reduced. Thus, for example, the number of times the medium ME1 is resupplied or back-fed to the conveyance path 49 is small, and the test pattern group TP0 can be printed in a short time.

Furthermore, since the test pattern group TP0 is formed in the lower-end print area AR4, the conveyance error caused by the conveyance via the downstream drive roller 52 having a smaller diameter than the upstream drive roller 51 can be effectively reduced. Also, since the test patterns (TP1, TP2) are pitch line groups, the adjustment value V can be calculated from the plurality of lines LN0, and the test pattern group TP0 useful for acquiring the adjustment value V with higher accuracy can be printed. Moreover, even when the range RG of the pitch line group in the conveyance direction D3 is equal to or less than the designed circumferential length PM of the spur gear 53, particularly, less than the circumferential length PM, or equal to or less than PM/2, the adjustment value V can be calculated regardless of the relationship between the circumferential length PM and the diameters of the drive rollers (51, 52), since the first test pattern TP1 based on the first angle θ1 as a reference and the second test pattern TP2 based on the second angle θ2 as a reference are formed in the cantilevered print area AR2. Therefore, the test pattern group TP0 with which the adjustment value V can be calculated regardless of the size of each member of the conveyance unit 50 can be printed.

### (4) Modification Examples

Various modification examples of the present disclosure are conceivable.

For example, the combination of colors of the liquid 36 is not limited to C, M, Y, and K, and may include orange, green, light cyan having a lower density than C, light magenta having a lower density than M, dark yellow having a higher density than Y, light black having a lower density than K, colorless for image quality improvement, and the like, in addition to C, M, Y, and K. Also, some of the colors C, M, Y, and K of the color combination of the liquid 36 may be omitted.

The agent that performs the above-described processing is not limited to the CPU, and may be an electronic component other than the CPU, such as an ASIC. Of course, a plurality of CPUs may cooperate to perform the above-described processing, or a CPU and another electronic component (for example, an ASIC) may cooperate to perform the above-described processing.

The drive rollers (51, 52) not only may convey the medium in the state of being in contact with the medium to be printed but also may convey a stacked body of a first medium to be printed and one or more second media in the state of being in contact with the second medium. The second medium includes a support medium such as a sheet or a film that supports the first medium, a protective medium such as a sheet or a film that protects the first medium, and the like.

Although the above-described rotary element is the spur gear 53, the rotary element may be a gear other than the spur gear, or may be a toothed belt, a chain, or the like. The rotary element may be a combination of a plurality of elements. For example, when the rotary element is a combination of a plurality of spur gears, the number of teeth of each spur gear may be used as the circumferential length, and the least common multiple of these numbers of teeth may be used as the number of teeth of the rotary element. Of course, the plurality of elements provided as the rotary element may be a combination of a plurality of gears other than spur gears, or may include a toothed belt, a chain, or the like.

As illustrated in FIG. 9, a test pattern group TP0 in which the rotation angle θ of the spur gear 53 is shifted by less than 180° between the first test pattern TP1 and the second test pattern TP2 may be printed in the cantilevered print area AR2. FIG. 9 illustrates the medium ME1 on which the second test pattern TP2 is formed in the cantilevered print area AR2 in the state where the spur gear 53 is at a rotation angle based on a plurality of second angles θ2 shifted from the first angle θ1 by k(n/m) cycles as a reference, where m=3 and n=1. Each test pattern (TP1, TP2) is a pitch line group including a plurality of lines LN0.

In the example shown in FIG. 9, the controller 10 performs the first control for forming the first test pattern TP1 in the upper-end print area AR3 and the lower-end print area AR4 in the state where the spur gear 53 is at a rotation angle based on the first angle θ1 as a reference. Also, the controller 10 performs the second control for forming the second test pattern TP2 with k=1 in the upper-end print area AR3 and the lower-end print area AR4 in the state where the spur gear 53 is at a rotation angle based on the second angle θ2=θ1+120°, which is shifted from the first angle θ1 by 120°, as a reference, and forming the second test pattern TP2 with k=2 in the upper-end print area AR3 and the lower-end print area AR4 in the state where the spur gear 53 is at a rotation angle based on the second angle θ2=θ1+240°, which is shifted from the first angle θ1 by 240°, as a reference. Thus, the first test pattern TP1 based on the first angle θ1 as a reference, the second test pattern TP2 based on the second angle θ2=θ1+120° with k=1 as a reference, and the second test pattern TP2 based on the second angle θ2=θ1+240° with k=2 as a reference are printed in the upper-end print area AR3 and the lower-end print area AR4.

From the test pattern group TP0 illustrated in FIG. 9, the control unit U1 can acquire a plurality of first individual errors from the first test pattern TP1, can acquire a plurality of second individual errors from the second test pattern TP2 with k=1, and can acquire a plurality of third individual errors from the second test pattern TP2 with k=2. Next, the control unit U1 can calculate the first average error from the plurality of first individual errors, can calculate the second average error from the plurality of second individual errors, and can calculate the third average error from the plurality of third individual errors. Therefore, the control unit U1 can calculate the adjustment value V by averaging the first average error, the second average error, and the third average error. As the control unit U1 stores the adjustment value V in the storage unit 23, the conveyance unit 50 adjusts the amount of conveyance according to the adjustment value V so that the conveyance error is reduced.

Of course, various combinations of m and n are conceivable, such as m=4 and n=1, m=5 and n=1, and m=5 and n=2.

### (5) Conclusions

As described above, according to various aspects of the present disclosure, configurations such as a printing device that can print a test pattern group useful for acquiring an adjustment value for reducing a conveyance error occurring in an area at an end part in a conveyance direction, of a print area on a medium, and an amount-of-conveyance adjustment method that reduces a conveyance error occurring in an area at an end part in a conveyance direction, of a print area on a medium, can be provided. Of course, the above-described basic effects and advantages can also be achieved by aspects only including elements according to the independent claims.

In addition, it is conceivable to employ a configuration in which the elements disclosed in the examples described above are interchanged with each other or the combination of the elements is changed, a configuration in which the elements disclosed in known technologies and the examples described above are interchanged with each other or the combination of the elements is changed, and the like. The present disclosure also includes such configurations and the like.

What is claimed is:

1. A printing device configured to be able to print a test pattern group for acquiring an adjustment value of an amount of conveyance of a medium, the printing device comprising:
a recording head configured to be able to eject droplets onto the medium;
a main scanning unit configured to move the recording head along a main scanning direction;
a conveyance unit configured to convey the medium in a conveyance direction intersecting the main scanning direction; and
a control unit configured to control operations of the recording head, the main scanning unit, and the conveyance unit, wherein
the conveyance unit includes:
an upstream drive roller including a first gear and located upstream of the recording head in the conveyance direction;
a downstream drive roller including a second gear and located downstream of the recording head in the conveyance direction; and
a rotary element meshing with the first gear and the second gear,
at least one of the upstream drive roller and the downstream drive roller rotates in contact with the medium and thus conveys the medium in the conveyance direction,
a print area on the medium includes a cantilevered print area where the medium is conveyed in a state where one of the upstream drive roller and the downstream drive roller is separated from the medium,
the test pattern group includes a first test pattern and one or more second test patterns, and
the control unit performs
first control for forming the first test pattern in the cantilevered print area in a state where the rotary element is in a phase based on a first phase as a reference, and
second control for forming the second test pattern in the cantilevered print area in a state where the rotary element is in a phase based on one or more second phases shifted from the first phase by k(n/m) cycles as a reference, where m is an integer of 2 or more, n is an integer of 1 or more and less than m, and k is all integers from 1 to m−1.

2. The printing device according to claim 1, wherein
the control unit performs the second control of forming the second test pattern in the cantilevered print area in a state where the rotary element is in a phase based on the second phase shifted from the first phase by ½ cycles as a reference.

3. The printing device according to claim 1, wherein
the downstream drive roller has a smaller diameter than the upstream drive roller,
the cantilevered print area includes a lower-end print area where the medium is conveyed by rotation of the downstream drive roller in a state where the upstream drive roller is separated from the medium, and
the control unit performs the first control for forming the first test pattern in the lower-end print area and the second control for forming the second test pattern in the lower-end print area.

4. The printing device according to claim 1, wherein
the first test pattern and the second test pattern are a pitch line group in which a plurality of lines along the main scanning direction are arranged at intervals in the conveyance direction.

5. The printing device according to claim 4, wherein
a range of the pitch line group in the conveyance direction is equal to or less than a designed circumferential length of the rotary element.

6. An amount-of-conveyance adjustment method for a printing device, the printing device including a recording head configured to be able to eject droplets onto the medium, a main scanning unit configured to move the recording head along a main scanning direction, and a conveyance unit configured to convey the medium in a conveyance direction intersecting the main scanning direction, the printing device being configured to be able to print a test pattern group for acquiring an adjustment value of an amount of conveyance of the medium, wherein
the conveyance unit includes:
an upstream drive roller including a first gear and located upstream of the recording head in the conveyance direction;
a downstream drive roller including a second gear and located downstream of the recording head in the conveyance direction; and
a rotary element meshing with the first gear and the second gear,
at least one of the upstream drive roller and the downstream drive roller rotates in contact with the medium and thus conveys the medium in the conveyance direction,
a print area on the medium includes a cantilevered print area where the medium is conveyed in a state where one of the upstream drive roller and the downstream drive roller is separated from the medium,
the test pattern group includes a first test pattern and one or more second test patterns, and
the amount-of-conveyance adjustment method comprises:
a first process of forming the first test pattern in the cantilevered print area in a state where the rotary element is in a phase based on a first phase as a reference;
a second process of forming the second test pattern in the cantilevered print area in a state where the rotary element is in a phase based on one or more second phases shifted from the first phase by k(n/m) cycles as a reference, where m is an integer of 2 or more, n is an integer of 1 or more and less than m, and k is all integers from 1 to m−1; and
a third process of adjusting the amount of conveyance, based on the first test pattern and the one or more second test patterns.
